(19) United States
(12) Patent Application Publication
(10) Pub. No.: US 2003/0081806 A1
(43) Pub. Date: May 1, 2003

(54) Headphone earpiece cover

(76) Inventor: Wanda Fisher Young, Decatur, GA (US)

Correspondence Address: WANDA FISHER YOUNG, 2189 HIDDEN CREEK DRIVE, DECATUR, GA, 30035, US

(21) Appl. No.: 10/057,634

(22) Filed: Oct. 25, 2001

(51) Int. Cl. H04R 25/00

(52) U.S. Cl. 381/371; 381/370

(57) ABSTRACT

A headphone earpiece cover that the user may place over the earpiece to provide protection to the user from unknown and potentially harmful substances which may have been left on the head phone by a previous user. The outer perimeter of the sheet is adapted for a complete fit around the perimeter of a headphone earpiece such that the material substantially covers the earpiece.

### SUMMARY

To attain this, the present invention generally comprises a flexible material in a generally conical configuration having a generally circular outer perimeter and the center extended with several small holes to transmit sound. The outer perimeter of the material is adapted for fitting around the headphone earpiece. It is a further object of the present invention to provide protection to the user from unknown and potentially harmful substances which may have been left on the headphones by a previous user. A further object of this invention to provide a headphone covers which may be easily and efficiently manufactured and marketed. An even further object of the present invention is to provide a headphone cover which is disposable after use. Yet another object of this invention is to provide a headphone cover that is light in weight, but tear-resistant so that it will adequately, protects the user during use. It is another object of the present invention to provide a headphone earpiece cover having several small holes to facilitate sound transmission.

### DRAWINGS

FIG. 1 is a side view of the cover portion of the invention

FIG. 2 is a bottom view of the cover portion of the invention

FIG. 3 is a top view of the cover portion of the invention

### DESCRIPTION

The present invention relates to protective cover that a user may place over the earpiece of a headphone to protect the user from unknown and potentially harmful substances which may have been left on the headphone earpiece by a previous user.

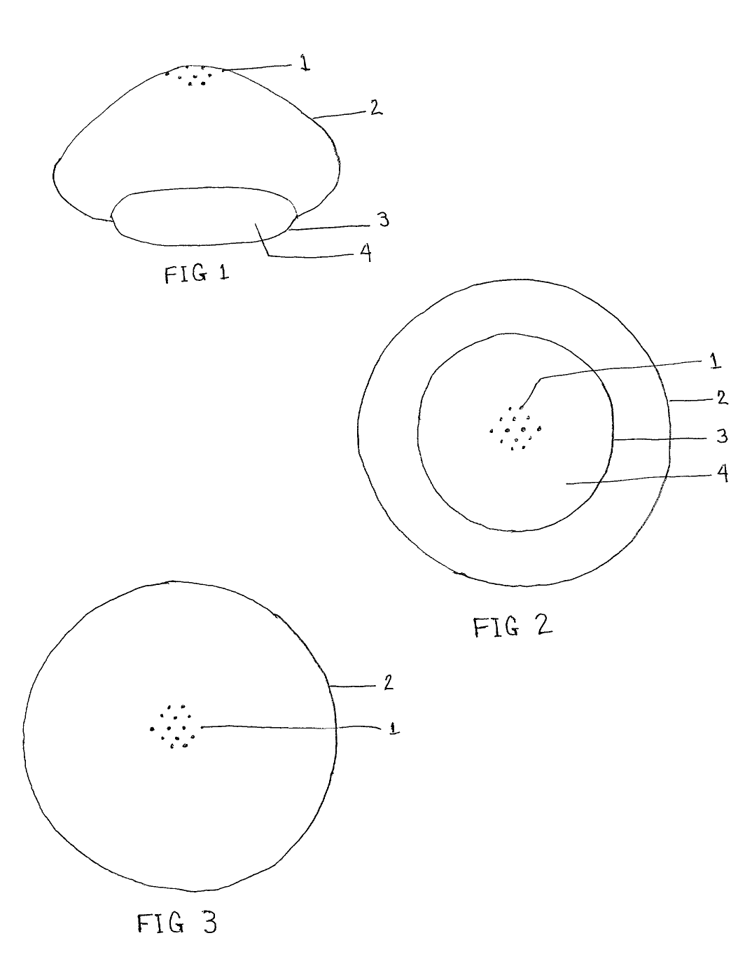

As can be seen by reference to the drawings, FIGS. 1-3, the headphone earpiece cover generally comprises of a flexible material 2 in a generally conical configuration having a generally circular outer perimeter 4 an opening to fit around the earpiece, small holes 1 centrally located through material 2and an elastic strip 3 attached to the outer edges of material. The headphone earpieces cover 2 is to be approximately circular in translucent shape, and has elastic strip 3 attached around its circumference.

In use, the open edge of the headphone earpiece cover, the elastic strips 3 designs to expand to form a complete cover over the headphone earpiece. The cover has several small holes 1 to facilitate sound transmission. After the user is finished using the headphone cover, the material 2 may be disposed of in the trash.

With respect to the above description then, it is to be realized that the optimum dimensional relationships for the parts of the invention, to include variations in size, materials, shape, form, function, assembly and use, are deemed readily apparent and obvious to one skilled in the art, and all equivalent relationships to those illustrated in the drawings and described in the specification are intended to be encompassed by the present invention.

### REFERENCE NUMERALS

1 small holes

2 cover materials

3 elastic strip

4 open circular perimeter

I claim:

1. A headphone earpiece cover, comprising:
A headphone earpiece cover will prevent direct contact between the surface of a person's skin and the headphone earpiece:
A flexible material in a generally conical configuration having a generally circular out perimeter and the center extended with small holes to facilitate sound transmission
the outer perimeter of the material being fitted around the perimeter of the headphone such that the material substantially covers the headphone earpiece.

2. A protection system for use with a headphone earpiece cover, the protection system comprising:
a protective cover formed of a quantity of flexible material which is sized to be able to surround the earpiece, the material including a central porting with a plurality of holes there through for facilitating sound transmission through the material to the earpiece during use of the protective cover, the outer edge cover being circular in shape including a plurality on expansion ridges formed to fit over the headphone earpieces; and
a protective package enclosing the protective cover, the protective package being rectangular in shape and have a thickness sufficient to package a quantity of the protective cover.

3. The headphone earpiece cover of claim 2, wherein the material comprises a material that can be easily disposed.

4. The headphone earpiece cover of claim 3, wherein said material comprises a paper material.

5. The headphone earpiece cover of claim 2, wherein the outer perimeter of the sheet has a diameter of a sufficient size to permit a fit around the headphone earpiece.

6. The protective system according to claim 2, wherein said material comprises a lightweight, low absorbency cloth.

7. The protection system according to claim 2, wherein said quantity of elastic comprises an elastic strip.

8. The protection system according to claim 2, wherein said material comprises a lightweight tear-resistant plastic.
